(19) United States
(12) Patent Application Publication
(10) Pub. No.: US 2005/0069706 A1
(43) Pub. Date: Mar. 31, 2005

(54) Particulate metal oxide

(76) Inventor: Lorna Margaret Kessell, North Yorkshire (GB)

Correspondence Address: MAYER, BROWN, ROWE & MAW LLP, 1909 K STREET, N.W., WASHINGTON, DC, 20006, US

(21) Appl. No.: 10/499,666

(22) PCT Filed: Dec. 20, 2002
(86) PCT No.: PCT/GB02/05840

(30) Foreign Application Priority Data
Dec. 21, 2001 (GB) 0130658.8

(51) Int. Cl. B32B 5/16

(52) U.S. Cl. 428/403; 106/157.8; 428/913

(57) ABSTRACT

A particulate metal oxide having a coating layer comprising phosphate wherein the mean length of the primary particles is in the range from 50 to 90 nm, and the mean width of the primary particles is in the range from 5 to 20 nm. The metal oxide is particularly suitable for forming aqueous dispersions. The metal oxide and aqueous dispersions thereof can be used in a sunscreen product that exhibits both effective UV protection and improved transparency.

### FIELD OF INVENTION

The present invention relates to a particulate coated metal oxide, a metal oxide dispersion and in particular to the use thereof in a sunscreen product.

### BACKGROUND

Metal oxides such as titanium dioxide, zinc oxide and iron oxides have been employed as attenuators of ultraviolet light in applications such as sunscreens, plastics films and resins. Due to the increased awareness of the link between ultraviolet light and skin cancer, there has been an increasing requirement for ultraviolet light protection in everyday skincare and cosmetics products. Unfortunately, existing commercially available metal oxide products, such as titanium dioxide, are not sufficiently transparent and can have an unacceptable whitening effect when used on the skin. There is a need for a metal oxide which exhibits improved transparency, reduced whitening, and provides broad spectrum ultraviolet light protection. There are particular problems involved in achieving the aforementioned properties in aqueous media.

Review of the Prior Art

GB-2205088-A discloses particulate acicular titanium dioxide having a coating layer of aluminium oxide and silicon oxide.

GB-2226018-A is directed to an aqueous dispersion of particulate acicular titanium dioxide containing an acrylic dispersing agent.

### SUMMARY OF THE INVENTION

We have now surprisingly discovered an improved metal oxide, which overcomes or significantly reduces at least one of the aforementioned problems.

Accordingly, the present invention provides a particulate metal oxide having a coating layer comprising phosphate wherein the mean length of the primary particles is in the range from 50 to 90 nm, and the mean width of the primary particles is in the range from 5 to 20 nm.

The present invention also provides a dispersion comprising particles of metal oxide having a coating layer comprising phosphate in a dispersing medium wherein the mean length of the primary particles is in the range from 50 to 90 nm, and the mean width of the primary particles is in the range from 5 to 20 nm.

The invention further provides a particulate metal oxide having a coating layer comprising phosphate, and having an extinction coefficient at 524 nm (E₅₂₄) in the range from 0.2 to 1.5 I/g/cm, an extinction coefficient at 450 nm (E₄₅₀) in the range from 0.1 to 2.0 Vg/cm, an extinction coefficient at 360 nm (E₃₆₀) in the range from 5 to 10 I/g/cm, an extinction coefficient at 308 nm (E₃₀₈) in the range from 35 to 65 I/g/cm, a maximum extinction coefficient E(max) in the range from 50 to 80 I/g/cm, and a λ(max) in the range from 260 to 290 nm.

The invention further provides a sunscreen product comprising a metal oxide or dispersion as defined herein.

The invention still further provides the use of a metal oxide or dispersion as defined herein in the manufacture of a sunscreen having reduced whiteness.

Preferably the metal oxide used in the present invention comprises an oxide of titanium, zinc or iron, and most preferably the metal oxide is titanium dioxide.

The preferred titanium dioxide particles comprise anatase and/or rutile crystal form. The titanium dioxide particles preferably comprise a major portion of rutile, more preferably greater than 60% by weight, particularly greater than 70%, and especially greater than 80% by weight of rutile, based on the total weight of titanium dioxide. The titanium dioxide particles preferably comprise in the range from 0.01 to 5%, more preferably 0.1 to 2%, and particularly 0.2 to 0.5% by weight of anatase, based on the total weight of titanium dioxide. In addition, the titanium dioxide particles preferably comprise less than 40%, more preferably less than 30%, and particularly less than 25% by weight of amorphous titanium dioxide, based on the total weight of titanium dioxide. The basic particles may be prepared by standard procedures, such as using the chloride process, or by the sulphate process, or by hydrolysis of an appropriate titanium compound such as titanium oxydichloride or an organic or inorganic titanate, or by oxidation of an oxidisable titanium compound, e.g. in the vapour state. The titanium dioxide particles are preferably prepared by the hydrolysis of a titanium compound, particularly of titanium oxydichloride.

The particles of metal oxide according to the present invention have a coating layer, preferably inorganic, comprising phosphate. The preferred amount of phosphate in the coating layer is in the range from 0.1 to 12%, more preferably 0.5 to 6%, particularly 1 to 3%, and especially 1.5 to 2.5% by weight of phosphorous, based on the weight of metal oxide core particles.

The coating layer may be formed by adding a, preferably water soluble, phosphate or salt of phosphoric acid to a dispersion, normally aqueous, to uncoated metal oxide core particles. Suitable water soluble phosphates include metal, preferably alkali metal, or ammonium phosphates such mono-, di- or tri-sodium phosphate, mono-, di- or tri-potassium phosphate or alternatively a polymeric phosphate, such as a polymeric alkali metal phosphate, for example tri-sodium polyphosphate or sodium hexametaphosphate. Polymeric phosphates are preferred, particularly sodium hexametaphosphate.

The coating layer is preferably formed by precipitating the phosphate with a suitable cation, preferably metal, on to the surface of the metal oxide particles. Suitable metal cations include aluminium, zirconium and cerium, and preferably aluminium. The precipitation of the phosphate, preferably metal phosphate, and particularly aluminium phosphate, can be achieved by adjusting the pH of the dispersion by the addition of acid or alkali, as appropriate. The amount of the preferred metal, particularly aluminium, in the coating layer is preferably in the range from 0.2 to 20%, more preferably 1.5 to 10%, particularly 3 to 7%, and especially 4 to 5% by weight, based on the weight of metal oxide core particles.

The amount of phosphorous in the coating layer is preferably in the range from 2 to 35%, more preferably 5 to 25%, particularly 8 to 20%, and especially 10 to 14% by weight based on the weight of the coating layer. The amount of metal, preferably aluminium, in the coating layer is preferably in the range from 10 to 55%, more preferably 20 to 50%, particularly 25 to 45%, and especially 30 to 40% by weight based on the weight of the coating layer.

The preferred metal compound, more preferably water soluble, particularly in the form of a salt such as a sulphate or oxide, preferably sulphate, can be added together with the phosphate to the dispersion of metal oxide particles. In a preferred embodiment of the invention, the coating layer is formed by adding sodium hexametaphosphate and aluminium sulphate to an aqueous slurry or dispersion of metal oxide particles, and the pH adjusted in order to achieve precipitation of aluminium phosphate.

In a preferred embodiment of the invention, the coating layer comprises aluminium oxide and/or aluminium hydroxide (hereinafter both referred to as alumina), in addition to the aforementioned phosphate, preferably aluminium phosphate. The amount of alumina present in the coating layer is preferably in the range from 1 to 20%, more preferably 3 to 14%, particularly 6 to 11%, and especially 7 to 9% by weight, based on the weight of metal oxide core particles. Alumina can be formed as a component in the coating layer by adding aluminium sulphate and/or a metal aluminate, preferably water soluble, to the dispersion of metal oxide particles. Sodium aluminate is a particularly preferred metal aluminate. Precipitation of alumina on the surface of the metal oxide particles can also be achieved by suitable control of pH.

The ratio by weight of the preferred aluminium phosphate to alumina present in the coating layer is suitably in the range from 0.1 to 1.8:1, preferably 0.2 to 1.2:1, more preferably 0.3 to 0.8:1, particularly 0.4 to 0.65:1, and especially 0.5 to 0.6:1.

Thus, in a particularly preferred embodiment of the invention, the coating layer is formed by adding sodium hexametaphosphate, aluminium sulphate and sodium aluminate to a dispersion of metal oxide particles, and the pH adjusted to in order to achieve precipitation of both aluminium phosphate and alumina.

The individual or primary metal oxide particles are preferably acicular in shape and have a long axis (maximum dimension or length) and short axis (minimum dimension or width). The third axis of the particles (or depth) is preferably approximately the same dimensions as the width. The size of the primary particles can be suitably measured using electron microscopy. The size of a particle can be determined by measuring the length and width of a filler particle selected from a photographic image obtained by using a transmission electron microscope. Mean values can be determined from the measurements of at least 300 particles, as described herein.

The mean length by number of the primary metal oxide particles is in the range from 50 to 90 nm, preferably 55 to 77 nm, more preferably 55 to 73 nm, particularly 60 to 70 nm, and especially 60 to 65 nm. The mean width by number of the particles is in the range from 5 to 20 nm, preferably 8 to 19 nm, more preferably 10 to 18 nm, particularly 12 to 17 nm, and especially 14 to 16 nm.

The size distribution of the primary metal oxide particles can also have a significant effect on the final properties of, for example, a sunscreen product comprising the metal oxide. In a preferred embodiment of the invention suitably at least 40%, preferably at least 50%, more preferably at least 60%, particularly at least 70%, and especially at least 80% by number of particles have a length within the above preferred ranges given for the mean length. In addition, suitably at least 40%, preferably at least 50%, more preferably at least 60%, particularly at least 70%, and especially at least 80% by number of particles have a width within the above preferred ranges given for the mean width.

The primary metal oxide particles suitably have a mean aspect ratio d₁:d₂ (where d₁ and d₂, respectively, are the length and width of the particle) in the range from 2.0 to 8.0:1, preferably 3.0 to 6.5:1, more preferably 4.0 to 6.0:1, particularly 4.5 to 5.5:1, and especially 4.5 to 5.0:1.

The primary metal oxide particles suitably have a median volume particle diameter (equivalent spherical diameter corresponding to 50% of the volume of all the particles, read on the cumulative distribution curve relating volume % to the diameter of the particles—often referred to as the “D(v,0.5)” value), measured as herein described, in the range from 20 to 35 nm, preferably 23 to 33 nm, more preferably 25 to 31 nm, particularly 25 to 28, and especially 25 to 26 nm.

When formed into a dispersion, the particulate metal oxide according to the present invention suitably has a median volume particle diameter (equivalent spherical diameter corresponding to 50% of the volume of all the particles, read on the cumulative distribution curve relating volume % to the diameter of the particles—often referred to as the “D(v,0.5)” value)) (hereinafter referred to as dispersion particle size), measured as herein described, of less than 45 nm, preferably less than 40 nm, more preferably in the range from 17 to 35 nm, particularly 20 to 30 nm, and especially 22 to 25 nm.

The size distribution of the metal oxide particles in dispersion can also be an important parameter in obtaining, for example, a sunscreen product having the required properties. The metal oxide particles in dispersion suitably have no more than 16% by volume of particles having a volume diameter of less than 14 nm, preferably less than 16 nm, more preferably less than 18 nm, particularly less than 20 nm, and especially less than 22 nm. In addition, the metal oxide particles in dispersion suitably have more than 84% by volume of particles having a volume diameter of less than 45 nm, preferably less than 38 nm, more preferably less than 34 nm, particularly less than 30 nm, and especially less than 26 nm.

It is preferred that in dispersion none of the metal oxide particles should have an actual particle size exceeding 150 nm. Particles exceeding such a size may be removed by milling processes which are known in the art. However, milling operations are not always totally successful in eliminating all particles greater than a chosen size. In practice, therefore, the size of 95%, preferably 99% by volume of the particles should not exceed 150 nm.

The dispersion particle size of the matal oxide particles describes herein may be measured by electron microscope, coulter counter, sedimentation analysis and static or dynamic light scattering. Techniques based on sedimentation analysis are preferred. The median particle size may be determined by plotting a cumulative distribution curve representing the percentage of particle volume below chosen particle sizes and measuring the 50th percentile. The median particle volume diameter of the metal oxide particles in dispersion is suitably measured using a Brookhaven particle sizer, as described herein.

In a particularly preferred embodiment of the invention, the metal oxide particles have a BET specific surface area, measured as described herein, of greater than 40, more preferably in the range from 50 to 140, particularly 60 to 120, and especially 65 to 100 m²/g.

The metal oxide particles exhibit improved transparency preferably having an extinction coefficient at 524 nm (E₅₂₄), measured as herein described, of less than 2.0, more preferably in the range from 0.2 to 1.5, particularly 0.4 to 1.0, and especially 0.5 to 0.8 l/g/cm. In addition, the metal oxide particles preferably have an extinction coefficient at 450 nm (E₄₅₀), measured as herein described, of less than 3.0, more preferably in the range from 0.1 to 2.0, particularly 0.5 to 1.5, and especially 0.7 to 1.0 I/g/cm.

The metal oxide particles exhibit effective UV absorption, suitably having an extinction coefficient at 360 nm (E₃₆₀), measured as herein described, of greater than 3, preferably greater than 4, more preferably in the range from 5 to 10, particularly 5.5 to 8, and especially 6 to 7.5 I/g/cm. The metal oxide particles also suitably have an extinction coefficient at 308 nm (E₃₀₈), measured as herein described, of greater than 30, preferably in the range from 35 to 65, more preferably 40 to 60, particularly 45 to 55, and especially 46 to 50 I/g/cm.

The metal oxide particles suitably have a maximum extinction coefficient E(max), measured as herein described, of greater than 45, preferably in the range from 50 to 80, more preferably from 55 to 75, particularly 60 to 70, and especially 65 to 70 l/g/cm. The metal oxide particles suitably have a λ(max), measured as herein described, in the range from 260 to 290, preferably 265 to 285, more preferably 268 to 282, particularly 270 to 280 nm, and especially 275 to 280 nm.

The metal oxide particles suitably exhibit reduced whiteness, preferably having a change in whiteness ΔL of a sunscreen product containing the particles, measured as herein described, of less than 3, more preferably in the range from 0.5 to 2.5, and particularly 1.0 to 2.0. In addition, a sunscreen product containing the particles preferably has a whiteness index, measured as herein described, of less than 100%, more preferably in the range from 10 to 80%, particularly 20 to 60%, and especially 30 to 50%.

The metal oxide particles suitably have reduced photogreying, preferably having a photogreying index, measured as herein described, of less than 15, more preferably in the range from 1 to 10, particularly 2 to 7, and especially 3 to 5.

A composition, preferably a sunscreen product, containing the metal oxide particles defined herein suitably has a Sun Protection Factor (SPF), measured as herein described, of greater than 10, preferably greater than 15, more preferably greater than 20, particularly greater than 25, and especially greater than 30 and up to 40.

The metal oxide particles according to the present invention provide a surprising combination of both improved photostability and dispersibility, particularly when dispersed in aqueous media.

The particulate metal oxide according to the present invention may be in the form of a free-flowing powder. A powder having the preferred particle sizes for the metal oxide particles, as described herein, may be produced by milling processes known in the art. The final milling stage of the metal oxide is suitably carried out in dry, gas-bome conditions to reduce aggregation. A fluid energy mill can be used in which the aggregated metal oxide powder is continuously injected into highly turbulent conditions in a confined chamber where multiple, high energy collisions occur with the walls of the chamber and/or between the aggregates. The milled powder is then carried into a cyclone and/or bag filter for recovery. The fluid used in the energy mill may be any gas, cold or heated, or superheated dry steam.

The particulate metal oxide according to the present invention may be formed into a slurry, or preferably a liquid dispersion, in any suitable aqueous or organic liquid medium. By dispersion is meant a true dispersion, ie where the solid particles are stable to aggregation. The particles in the dispersion are relatively uniformly dispersed and resistant to settling out on standing, but if some settling out does occur, the particles can be easily redispersed by simple agitation.

Cosmetically acceptable materials are preferred as the liquid medium. A useful organic medium is a liquid oil such as vegetable oils, e.g. fatty acid glycerides, fatty acid esters and fatty alcohols. A preferred organic medium is a siloxane fluid, especially a cyclic oligomeric dialkylsiloxane, such as the cyclic pentamer of dimethylsiloxane known as cyclomethicone. Alternative fluids include dimethylsiloxane linear oligomers or polymers having a suitable fluidity and phenyltris(trimethylsiloxy)silane (also known as phenyltrimethicone). The particulate metal oxide is particularly suitable for use in aqueous media, and may be formed into an aqueous slurry, or preferably an aqueous dispersion. A surprising feature of the present invention is that aqueous dispersions can be produced which contain at least 30%, preferably at least 35%, more preferably at least 40%, particularly at least 45%, especially at least 50%, and generally up to 55% or even 60% by weight of the total weight of the dispersion, of metal oxide particles as described herein.

The metal oxide dispersions may also contain a dispersing agent in order to improve the properties thereof. The dispersing agent is suitably present in the range from 1 to 50%, preferably 2-to 30%, more preferably 3 to 20%, particularly 4 to 15%, and especially 5 to 10% by weight based on the total weight of metal oxide particles.

Suitable dispersing agents for use in an organic medium include substituted carboxylic acids, soap bases and polyhydroxy acids. Typically the dispersing agent can be one having a formula X.CO.AR in which A is a divalent bridging group, R is a primary secondary or tertiary amino group or a salt thereof with an acid or a quaternary ammonium salt group and X is the residue of a polyester chain which together with the —CO— group is derived from a hydroxy carboxylic acid of the formula HO—R′—COOH. As examples of typical dispersing agents are those based on ricinoleic acid, hydroxystearic acid, hydrogenated castor oil fatty acid which contains in addition to 12-hydroxystearic acid small amounts of stearic acid and palmitic acid. Dispersing agents based on one or more polyesters or salts of a hydroxycarboxylic acid and a carboxylic acid free of hydroxy groups can also be used. Compounds of various molecular weights can be used. Other suitable dispersing agents are those monoesters of fatty acid alkanolamides and carboxylic acids and their salts. Alkanolamides are based on ethanolamine, propanolamine or aminoethyl ethanolamine for example. Alternative dispersing agents are those based on polymers or copolymers of acrylic or methacrylic acids, e.g. block copolymers of such monomers. Other dispersing agents of similar general form are those having epoxy groups in the constituent radicals such as those based on the ethoxylated phosphate esters. The dispersing agent can be one of those commercially referred to as a hyper dispersant.

Suitable dispersing agents for use in the preferred aqueous medium include a polymeric acrylic acid or a salt thereof. Partially or fully neutralized salts are usable e.g. the alkali metal salts and ammonium salts. Examples of dispersing agents are polyacrylic acids, substituted acrylic acid polymers, acrylic copolymers, sodium and/or ammonium salts of polyacrylic acids and sodium and/or ammonium salts of acrylic copolymers. Such dispersing agents are typified by polyacrylic acid itself and sodium or ammonium salts thereof as well as copolymers of an acrylic acid with other suitable monomers such as a sulphonic acid derivative such as 2-acrylamido 2-methyl propane sulphonic acid. Comonomers polymerisable with the acrylic or a substituted acrylic acid can also be one containing a carboxyl grouping. Usually the dispersing agents have a molecular weight of from 1,000 to 10,000 and are substantially linear molecules.

In one preferred embodiment of the invention, the dispersing agent in aqueous medium comprises a, preferably water soluble, phosphate or salt of phosphoric acid. Suitable water soluble phosphates include metal, preferably alkali metal, or ammonium phosphates such mono-, di- or tri-sodium phosphate, mono-, di- or tri-potassium phosphate or alternatively a polymeric phosphate, such as a polymeric alkali metal phosphate, for example tri-sodium polyphosphate or sodium hexametaphosphate. Polymeric phosphates are preferred, particularly sodium hexametaphosphate. In a further preferment, the dispersing agent is the same material which is used to form the phosphate coating layer on the metal oxide particles, especially sodium hexametaphosphate.

In a particular preferment, the dispersing agent in aqueous medium is a mixture of one or more of the aforementioned organic dispersing agents, preferably polyacrylic acid, and one or more of the aforementioned phosphorous containing dispersing agents, preferably sodium hexametaphosphate. The dispersing agent mixture preferably contains the two components present at a ratio of 10 to 90%:10 to 90%, more preferably 30 to 70%:30 to 70%, and especially 40 to 60%:40 to 60% by weight.

Alternatively, the particulate metal oxide may be in the form of a lotion or cream of a solid and/or semi-solid dispersion. Suitable solid or semi-solid dispersions may contain, for example, in the range from 50 to 90%, preferably 60 to 85% by weight of particulate metal oxide according to the present invention, together with any one or more of the liquid media disclosed herein, or a high molecular polymeric material, such as a wax.

The particulate metal oxide and dispersions of the present invention are useful as ingredients for preparing sunscreen compositions, especially in the form of emulsions. The dispersion may further contain conventional additives suitable for use in the intended application, such as conventional cosmetic ingredients used in sunscreens. The particulate metal oxide according to the present invention may provide the only ultraviolet light attenuators in a sunscreen product according to the invention, but other sunscreening agents, such as other metal oxides and/or other organic materials may also be added. For example, the preferred titanium dioxide particles described herein may be used in combination with existing commercially available titanium dioxide and/or zinc oxide sunscreens. Suitable organic sunscreens for use with metal oxide according to the invention include p-methoxy cinnamic acid esters, salicylic acid esters, p-amino benzoic acid esters, non-sulphonated benzophenone derivatives, derivatives of dibenzoyl methane and esters of 2-cyanoacrylic acid. Specific examples of useful organic sunscreens include benzophenone-1, benzophenone-2, benzophenone-3, benzophenone-6, benzophenone-8, benzophenone-12, isopropyl dibenzoyl methane, butyl methoxy dibenzoyl methane, ethyl dihydroxypropyl PABA, glyceryl PABA, octyl dimethyl PABA, octyl methoxycinnamate, homosalate, octyl salicylate, octyl triazone, octocrylene, etocrylene, menthyl anthranilate, and 4-methylbenzylidene camphor.

The invention is illustrated by the following non-limiting example.

In this specification the following test methods have been used.

1) Particle Size Measurement of Primary Metal Oxide Particles

A small amount of metal oxide, typically 2 mg, was pressed into approximately 2 drops of an oil, for one or two minutes using the tip of a steel spatula. The resultant suspension was diluted with solvent and a carbon-coated grid suitable for transmission electron microscopy was wetted with the suspension and dried on a hot-plate. Approximately 18 cm×21 cm photographs were produced at an appropriate, accurate magnification. Generally about 300-500 crystals were displayed at about 2 diameters spacing. A minimum number of 300 primary particles were sized using a transparent size grid consisting of a row of circles of gradually increasing diameter, representing spherical crystals. Under each circle a series of ellipsoid outlines were drawn representing spheroids of equal volume and gradually increasing eccentricity. The basic method assumes log normal distribution standard deviations in the 1.2-1.6 range (wider crystal size distributions would require many more crystals to be counted, for example of the order of 1000). The method described above has been found to be suitable for producing almost totally dispersed distributions of primary metal oxide particles whilst introducing minimal crystal fracture. Any residual aggregates (or secondary particles) are sufficiently well defined that they, and any small debris, can be ignored, and effectively only primary particles included in the count.

Mean length, mean width and length/width size distributions of the primary metal oxide particles can be calculated from the above measurements. Similarly, the median particle volume diameter of the primary particles can also be calculated.

2) Median Particle Volume Diameter Measurement of Metal Oxide Particles in Dispersion

A dispersion of metal oxide particles was produced by mixing 105.5 g of deionised water, 4.5 g of Calgon (sodium hexametaphosphate, ex Fischer Scientific), and 90 g of metal oxide. The mixture was passed through a horizontal bead mill, operating at approximately 1500 r.p.m. and containing zirconia beads as grinding media for 15 minutes. The dispersion of metal oxide particles was diluted with water to between 30 and 40 g/l, and the diluted sample was analysed on the Brookhaven BI-XDC particle sizer in centrifugation mode, and the median particle volume diameter measured.

3) BET Specific Surface Area of Metal Oxide Particles

The single point BET specific surface area was measured using a Micromeritics Flowsorb II 2300.

4) Change in Whiteness and Whiteness Index

A sunscreen formulation was coated on to the surface of a glossy black card and drawn down using a No 2 K bar to form a film of 12 μm wet thickness. The film was allowed to dry at room temperature for 10 minutes and the whiteness of the coating on the black surface (L_{F}) measured using a Minolta CR300 colourimeter. The change in whiteness ΔL was calculated by subtracting the whiteness of the substrate.(L_{S}) from the whiteness of the coating (L_{F}) and expressing the value relative to the formulation containing 5% by weight of metal oxide particles. The whiteness index is the percentage change in whiteness ΔL compared to a standard titanium dioxide (=100% value) (Tayca MT100T (ex Tayca Corporation)).

5) Photogreying Index

A metal oxide dispersion was placed inside a 6 cm×3 cm acrylic cell (containing a 2 cm×1.5 cm space), and the cell made air tight by clamping a glass slide over the top, ensuring that no air bubbles were present. The initial whiteness (L_{I}) was measured using a Minolta CR300 colourimeter. The cell was then placed on a turntable revolving at 30 rpm and exposed to UV light for 2 hours (a UV lamp containing 4 TL29D,16/09 tubes mounted 12 cm from the cell), and the whiteness (L_{T}) remeasured. The photogreying index ΔL=L_{I}−L_{T}.

6) Sun Protection Factor

The Sun Protection Factor (SPF) of a sunscreen formulation was determined using the in vitro method of Diffey and Robson, J. Soc. Cosmet. Chem. Vol. 40, pp 127-133,1989.

### EXAMPLE 1

2 moles of titanium oxydichloride in acidic solution were reacted with 6 moles of NaOH in aqueous solution, with stirring, in a 3 litre glass vessel. After the initial reaction phase, the temperature was increased to above 70° C., by heating at a rate of approximately 1° C./min, and stirring continued for at least another 60 minutes. The mixture was then neutralised by the addition of NaOH in aqueous solution, and allowed to cool below 70° C.

To the resultant dispersion, a solution of sodium hexametaphosphate was added, equivalent to 4% by weight P₂O₅ on TiO₂ weight over a period of 20 minutes. The mixture was stirred for at least another 30 minutes. An acidic solution of aluminium sulphate was added, equivalent to 3% by weight Al₂O₃ on weight of TiO₂ was added over a period of 20 minutes, and the reaction mixture again stirred for at least a further 30 minutes. An alkaline solution of sodium aluminate was added over a period of 40 minutes, equivalent to 6% by weight Al₂O₃ on TiO₂ weight, maintaining pH between 10.0 and 10.5 by addition of 36% hydrochloric acid as required. The reaction mixture was stirred for a further 45 minutes. The temperature of the reaction mixture was maintained at 50° C. throughout the reactions.

The dispersion was neutralised to pH 5.5 to 6.0 by adding 36% hydrochloric acid solution over 30 minutes. The neutralised slurry was aged for 15 minutes whilst being stirred. The slurry was then filtered to produce a filter cake, which was then washed repeatedly with demineralised water until the cake conductivity (when a small sample was reslurried to 100 μl) was less than 500 μs. The filter cake was dried in an oven at 105° C. for 16 hours and then micropulverised using a hammer mill to produce particulate titanium dioxide having a phosphate coating.

A dispersion of metal oxide particles was produced by mixing 105.5 g of deionised water, 4.5 g of Calgon (sodium hexametaphosphate, ex Fischer Scientific), and 90 g of the titanium dioxide produced above. The mixture was passed through a horizontal bead mill containing zirconia beads as grinding media, operating at approximately 1500 r.p.m. for 15 minutes. A fluid dispersion was produced.

The particulate titanium dioxide and dispersion were subjected to the test procedures described herein, and exhibited the following properties:

Primary Particle Size

i) Mean length 64 nm,
ii) Mean width=14.5 nm,
iii) Mean aspect ratio=4.4, and
iv) D (v,0.5)=26.5 nm.
   Dispersion Particle Size
i) D (v,0.5)=23.5 nm,
ii) 16% by volume of particles have volume diameter less than 18 nm,
iii) 84% by volume of particles have volume diameter less than 34 nm, and
iv) BET specific surface area=100 m²/g.

0.1 g of the milled titanium dioxide dispersion produced above was diluted with 100 ml of water, and then further diluted with water in the ratio sample:water of 1:19. The total dilution was 1:20,000.

The diluted sample was then placed in a spectrophotometer (Perkin-Elmer Lambda 2 UVNIS Spectrophotometer) with a 1 cm path length and the absorbance, of UV and visible light measured. Extinction coefficients were calculated from the equation A=E.c.I, where A=absorbance, E=extinction coefficient in litres per gram per cm, c=concentration in grams per litre, and I=path length in cm.

The results were as follows;

| E₅₂₄ | E₃₀₈ | E₃₆₀ | E(max) | λ(max) |
|---|---|---|---|---|
| 0.9 | 46.5 | 6.59 | 68 | 276 |

The titanium dioxide dispersion produced above was used to prepare a sunscreen formulation having the following composition;

| | % by weight |
|---|---|
| Phase A: | |
| ARLACEL 165 (trade mark, ex Uniqema) | 3.0 |
| Lorol C18 (ex Cognis) | 0.5 |
| SPAN 60 (trade mark, ex Uniqema) | 3.0 |
| TWEEN 60 (trade mark, ex Unqema) | 0.4 |
| Petroleum jelly | 3.0 |
| DC 200 fluid (ex Dow Corning) | 1.0 |
| ESTOL 3609 (trade mark, ex Uniqema) | 6.0 |
| PRIPURE 3759 (trade mark, ex Uniqema) | 8.0 |
| Antaron V-220 (ex ISP) | 2.5 |
| Phase B: | |
| Water; pure | 44.7 |
| Glycerine BP | 5.0 |
| Aloe Vera Gel 10:1 | 0.7 |
| Keltrol RD (ex Nutrasweet Kelco) | 0.1 |
| Titanium dioxide dispersion | 18.8 |
| Phase C: | |
| Water; pure | 2.5 |
| Phenonip (ex Clariant) | 0.6 |
| Germall 115 (ex ISP) | 0.3 |

The ingredients of aqueous phase B were mixed and heated to 75° C. The ingredients of phase A were mixed and heated to 70-75° C. and slowly added to the phase B with high shear mixing, followed by homogenization in a Ultra Turrax T25 homogeniser. The mixture was cooled with moderate stirring and the preservative phase C added at 45° C. Stirring was continued until the mixture cooled to room temperature. The Sun Protection Factor of the sunscreen formulation was measured and a value of 20 was obtained.

The above example illustrates the improved properties of a particulate metal oxide, dispersion and sunscreen product according to the present invention.

1. A particulate metal oxide having a coating layer comprising phosphate wherein the mean length of the primary particles is in the range from 50 to 90 nm, and the mean width of the primary particles is in the range from 5 to 20 nm.

2. A dispersion comprising particles of metal oxide having a coating layer comprising phosphate in a dispersing medium wherein the mean length of the primary particles is in the range from 50 to 90 nm, and the mean width of the primary particles is in the range from 5 to 20 nm.

3. A metal oxide or dispersion according to claim 1, wherein the primary particles have a mean length in the range from 55 to 73 nm, preferably 60 to 70 nm, and a mean width in the range from 10 to 18 nm, preferably 12 to 17 nm.

4. A metal oxide or dispersion according to claim 1, wherein at least 70% of the particles have a length in the range from 55 to 73 nm.

5. A metal oxide or dispersion according to claim 4 wherein at least 70% of the particles have a length in the range from 60 to 70 nm.

6. A metal oxide or dispersion according to claim 1, wherein the median particle volume diameter of the primary particles is in the range from 25 to 31 nm.

7. A metal oxide or dispersion according to claim 1, wherein the median particle volume diameter of the particles in dispersion is less than 45 nm, preferably in the range from 20 to 30 nm.

8. A metal oxide or dispersion according to claim 1, wherein no more than 16% by volume of the particles in dispersion have a volume diameter of less than 18 nm, preferably less than 20 nm.

9. A metal oxide or dispersion according to claim 1 wherein more than 84% by volume of the particles in dispersion have a volume diameter of less than 34 nm, preferably less than 30 nm.

10. A metal oxide or dispersion according to claim 1, wherein the amount of phosphate in the coating layer is in the range from 0.1 to 12% by weight of phosphorous, based on the weight of metal oxide core particles.

11. A metal oxide or dispersion according to claim 1, wherein the amount of metal cation in the coating layer is in the range from 0.2 to 20% by weight, based on the weight of metal oxide core particles.

12. A metal oxide or dispersion according to claim 11 wherein the metal comprises aluminium.

13. A metal oxide or dispersion according to claim 1, wherein the coating layer additionally comprises aluminium oxide and/or aluminium hydroxide.

14. A metal oxide or dispersion according to claim 13 wherein the coating layer comprises aluminium phosphate and (aluminium oxide and/or aluminium hydroxide) at a ratio by weight in the range from 0.1 to 1.8:1

15. A dispersion according to claim 2 comprising an aqueous medium.

16. An aqueous dispersion according to claim 15 comprising at least 30% by weight of metal oxide particles.

17. An aqueous dispersion according to claim 15 comprising a phosphorous containing dispersing agent.

18. A metal oxide or dispersion according to claim 1, wherein the particles of metal oxide have an extinction coefficient at 524 nm (ES24) in the range from 0.2 to 1.5, preferably 0.4 to 1.0 I/G/CM.

19. A metal oxide or dispersion according to claim 1, wherein the particles of metal oxide have an extinction coefficient at 360 nm (E360) IN the range from 5 to 10, preferably 5.5 to 8 I/G/CM.

20. A particulate metal oxide having a coating layer comprising phosphate, and having an extinction coefficient at 524 nm (ES24) in the range from 0.2 to 1.5 I/G/CM, an extinction coefficient at 450 nm (E4SO) in the range from 0.1 to 2.0 I/G/CM, an extinction coefficient at 360 nm (EGO) in the range from 5 to 10 I/G/CM, an extinction coefficient at 308 nm (E308) in the range from 35 to 65 I/G/CM, a maximum extinction coefficient E (max) in the range from 50 to 80 I/G/CM, and a K (max) in the range from 260 to 290 nm.

21. A metal oxide according to claim 20 having a photogreying index in the range from 1 to 10.

22. A sunscreen product comprising a metal oxide or dispersion as defined in claim 1.

23. A sunscreen product according to claim 22 which is transparent when applied to the skin and has a change in whiteness AL in the range from 0.5 to 2.5.

24. A sunscreen product according to claim 22 having a whiteness index in the range from 10% to 80%.

25. A sunscreen product according to claim 22 having a Sun Protection Factor (SPF) of greater than 15, preferably greater than 20.

26. The use of a metal oxide or dispersion as defined in claim 1 in the manufacture of a sunscreen having reduced whiteness.
